(19) United States
(12) Patent Application Publication
(10) Pub. No.: US 2005/0116209 A1
(43) Pub. Date: Jun. 2, 2005

(54) Image correction device

(76) Inventors: Michiharu Yamamoto, Carlsbad, CA (US); Nasser Peyghambarian, Tucson, AZ (US); Guoqiang Li, Tucson, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/954,756

(22) Filed: Sep. 30, 2004

Related U.S. Application Data
(60) Provisional application No. 60/508,930, filed on Oct. 6, 2003.

(51) Int. Cl. G03B 11/00

(52) U.S. Cl. 252/582

(57) ABSTRACT

An image correction device includes a photorefractive polymer containing a tertiary aryl amine selected from the group consisting of: 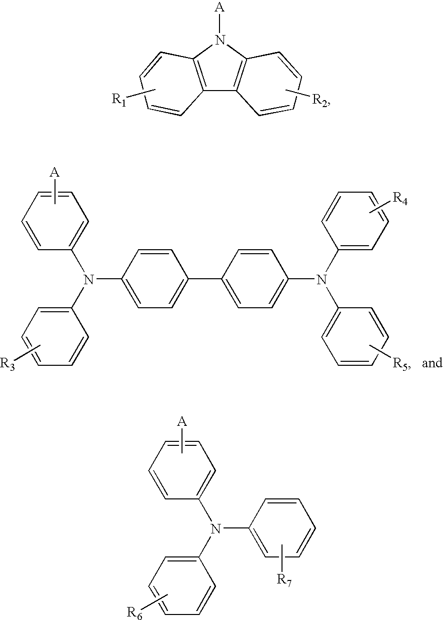 wherein A is a linking atom, and
wherein R₁, R₂, R₃, R₄, R₅, R₆, and R₇ are each independently selected from the group consisting of hydrogen, C₁-C₁₀ alkyl, C₁-C₁₀ alkoxy, and C₆-C₁₀ aryl.

This application claims the benefit of U.S. Provisional Application No. 60/508,930, filed on Oct. 6, 2003.

### BACKGROUND OF THE INVENTION

1. Field of the Invention

This application relates generally to image correction devices that comprise photorefractive polymers. More particularly, it relates to image correction devices in which the photorefractive polymer comprises a tertiary aryl amine group.

2. Description of the Related Art

Photonics is the technology of generating and harnessing light and other forms of radiant energy whose quantum unit is the photon. The science includes light emission, transmission, refraction, amplification and detection by optical components and instruments, lasers and other light sources, fiber optics, electro-optical instrumentation, related hardware and electronics, and sophisticated systems. The range of applications of photonics extends from energy generation to detection to communications and information processing.

Photorefractive materials play an active role in many photonics devices such as optical switches, holographic recording devices, optical signal amplifiers, and optical wavelength multiplexers and de-multiplexers. A photorefractive material is one in which the refractive index varies according to changes in the light to which it is exposed. Examples of photorefractive materials include inorganic crystals such as BaTiO₃, LiNbO₃, Bi₁₂SiO₂₀, Bi₁₂GeO₂₀, InP, GaAs, GaP, and CdTe. Photorefractive organic materials such as organic crystals and photorefractive polymers have also been reported, see, e.g., U.S. Pat. No. 5,064,264.

Considerable research efforts have been devoted to real-time restoration of distorted images (image correction) with low-cost and high-performance adaptive optical systems. All optical technologies using phase conjugation or two-beam coupling effects in photorefractive materials are attractive.

The PR polymers may have more advantage because of a response time in the millisecond range, near 100% diffraction efficiency, high coupling gain coefficients, and have become an alternative to PR crystal due to their low cost, ease of fabrication, flexibility of synthesis.

### SUMMARY OF THE INVENTION

In an embodiment of the present invention, an image correction device is provided, comprising a photorefractive polymer, wherein the photorefractive polymer comprises a tertiary aryl amine selected from the group consisting of: 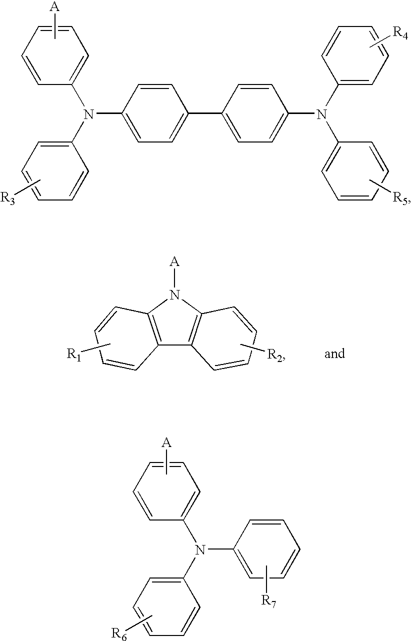
wherein A is a linking atom, and wherein R₁, R₂, R₃, R₄, R₅, R₆, and R₇ are each independently selected from the group consisting of hydrogen, C₁-C₁₀ alkyl, C₁-C₁₀ alkoxy, and C₆-C₁₀ aryl. Examples of preferred devices include, without limitation, holographic recorder, optical signal amplifier, optical wavelength division multiplexer/de-multiplexer, and optical switch.

All-optical real-time correction of wavefront distortion is important for high-quality image transmission, remote sensing, and laser beam propagation. By using a system comprising the photorefractive polymers with video-rate response and high diffraction efficiency, high-quality restoration of severely distorted images can be successfully performed. The system also has potential applications in biomedical imaging.

These and other embodiments are described in greater detail below.

These and other aspects of the invention will be readily apparent from the following description and from the appended drawings, which are meant to illustrate and not to limit the invention.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1 is a schematic illustration of typical optical setup for image correction device system.

FIG. 2(A) is a distorted image and FIG. 2(B) is a corrected image.

### DETAILED DESCRIPTION OF THE PREFERRED EMBODIMENTS

In optical information data processing field, a mathematical processing called optical de-convolution treatment is well-known for image correction. The de-convolution treatment is one of mathematical processing, which can restore original two function equations from a convoluted function. This method can be used for received image restoration from strained images by removing only the strained components.

Previously, in the field of object shape measurement system, which can be done by refraction light, scattering light, or emission light from objects, and optical image data transmission system, both optical filter and hologram can be utilized for image correction. The optical filter can be prepared by the strain component of received images. Also, the hologram can record strain components that are generated through optical path.

Instant preparation of the optical filter by the strained images has been impossible, because several processes, such as exposure to light sensitive materials and development of the materials, are required. Therefore, these rather complicated procedures were not satisfactory nor convenient to the case of real-time image cases. At the same time, prepared optical filter should be arranged to the original position very precisely, which makes this methodology more unpractical in some application.

In order to make the optical deconvolution process easier without repositioning of optical devices, easier system development has been expected. For the image correction, the photorefractive application device by hologram recording or reading out principle can be used. Conventionally, for this purpose, image correction devices which utilize photorefractive inorganic crystal, such as BaTiO₃, LiNbO₃, Bi₁₂SiO₂₀, Bi₁₂GeO₂₀, InP, GaAs, GaP, and CdTe, can be used and disclosed in Japanese Patent Application Laid-open No. 2001-337585, for an example.

Photorefractive polymers suitable for use in photonics devices include polymers comprising a tertiary aryl amine group. In this context, a tertiary aryl amine group is a nitrogen atom having three other atoms attached thereto, wherein at least one of the three is an aryl group and none of the three are hydrogen. Preferred tertiary aryl amine groups include those represented by the following structures (I), (II) and (III):

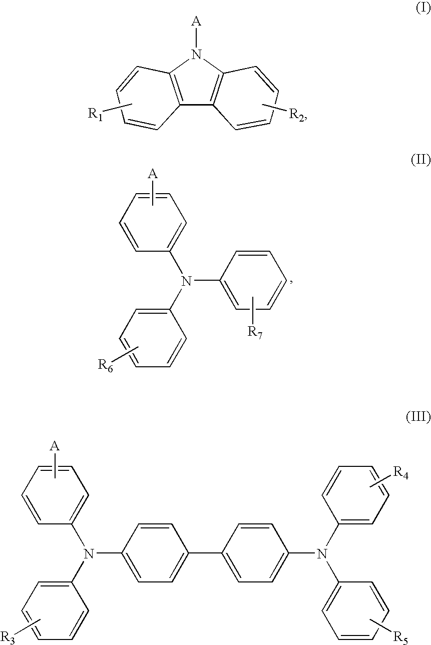

In structures (I), (II) and (III), A represents a linking atom, and R₁, R₂, R₃, R₄, R₅, R₆, and R₇ each independently represents a substituent selected from the group consisting of hydrogen, C₁-C₁₀ alkyl, C₁-C₁₀ alkoxy, and C₆-C₁₀ aryl. In this context, a linking atom is an atom that is capable of forming a chemical bond to at least two atoms. Thus, the linking atom in structures (I), (II) and (III) is the link between the tertiary aryl amine group and the remainder of the polymer to which it is attached. Preferred linking atoms include carbon nitrogen, oxygen and sulfur. For structure (I), the linking atom is more preferably a carbon atom. For structures (II) and (III), oxygen and carbon are preferred linking atoms. A linking group is a chemical group that contains a linking atom. For example, the linking groups —CH₂—, —CH═, and —C₆H₄— comprise a carbon linking atom and the linking groups —OCH₂CH₂— and —O—C₆H₄— comprise an oxygen linking atom. Preferred linking groups include —(CH₂)ₙ—, —O—(CH₂)ₙ—, —O—(CH₂)ₙ—O—, and —(CH₂CH₂O)ₙ—, where n is an integer in the range of 1 to 10, preferably 2 to 8; —C₆H₄—; —OC₆H₄—, and —O—C₆H₄—O—.

Preferred photorefractive polymers comprising a tertiary aryl amine group are preferably obtained by polymerization of the corresponding tertiary aryl amine monomers. Preferred monomers contain a polymerizable group and are preferably prepared by methods disclosed in U.S. Pat. No. 6,610,809, the entire disclosure of which is hereby incorporated herein by reference. In this context, a “polymerizable group” is a chemical group that reacts with other chemical groups to link monomers together to form a polymer. Examples of polymerizable groups include acrylate, methacrylate, acrylamide, alkene (including carbocyclic alkene), alkyne, styrene, cyclic N-phenyliminocarbonate, cyclic acid anhydride, sultam, lactam, lactone, and epoxy. Preferred polymerizable groups include vinyl, acrylate and methacrylate. The polymerizable group of the monomer is preferably attached to the tertiary aryl amine group through a linking atom. The polymerizable group and the tertiary aryl amine group can both be attached directly to the linking atom, or the polymerizable group can be attached to a linking group which is, in turn, attached to the tertiary aryl amine group. Non-limiting examples of preferred tertiary aryl amine monomers include those having structures (IV), (V) and (VI).

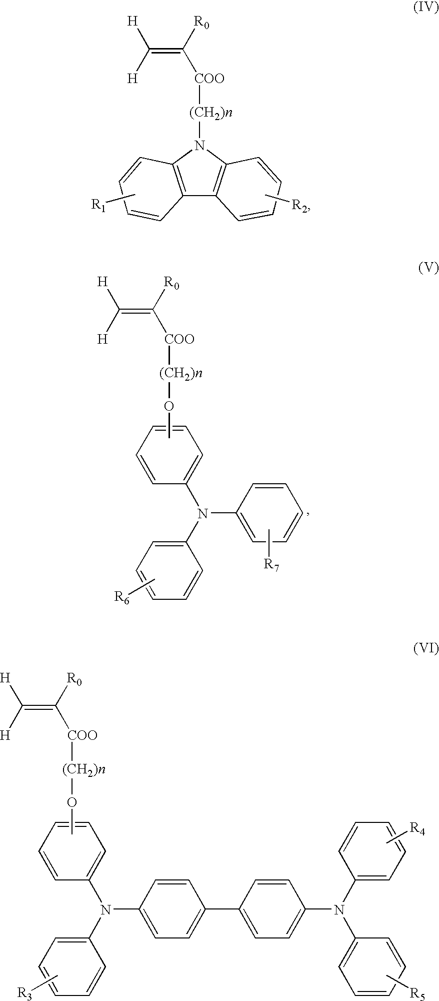

In structures (IV), (V) and (VI), R₁, R₂, R₃, R₄, R₅, R₆, and R₇ have the same meaning as described above for structures (I), (II), and (III); n is preferably an integer in the range of 1 to 10, more preferably 2 to 8, and R₀ is preferably methyl or hydrogen. Specific examples of preferred tertiary aryl amine monomers include carbazolylpropyl (meth)acrylate; 4-(N,N-diphenylamino)-phenylpropyl (meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Those skilled in the art will understand that, in this context, “(meth)” indicates that the monomers may contain a methacrylate or an acrylate polymerizable group.

Polymerization of the tertiary aryl amine monomers is preferably carried out by a chain polymerization technique. A chain polymerization technique is a polymerization that proceeds by a chain polymerization mechanism. A detailed description of chain polymerization mechanism can be found in G. Odian, Principles of Polymerization, John Wiley, New York, 2^{nd} Ed., 1981, pp. 7-10, which is hereby incorporated by reference. Chain polymerization techniques are often referred to by the type of initiation employed. Examples of chain polymerization techniques include radical polymerization, anionic polymerization, cationic polymerization, and transition metal catalysis (including ring-opening metathesis polymerization).

Free radical polymerization may be conducted in various solvents or in the bulk state and is preferably performed by intermixing a free radical initiator with the monomers. The amount of free radical initiator is preferably in the range of about 0.001% to about 1%, by weight based on monomer weight, depending on the efficiency of the initiator and the molecular weight desired for the resulting polymer. Various free radical sources known in the art may be used, including thermal initiators that contain an O—O, S—S, N—O or N═N bond, e.g., acyl peroxides such as acetyl peroxide and benzoyl peroxide, as well as azo compounds such as azobisisobutyronitrile (AlBN); and redox initiators that comprise a reductant and an oxidant, e.g., peroxides in combination with reducing agent such as ferrous ion, and combinations of inorganic reductants and oxidants, e.g., combinations of reductants such as HSO₃⁻, SO₃²⁻, S₂O₃²⁻, and S₂O₅²⁻ with oxidants such as Ag⁺, Cu²⁺, Fe³⁺, ClO₃⁻, and H₂O₂. If a solvent is used, it is preferred that the solvent have a low chain transfer constant if high molecular weight polymers are desired, preferably a chain transfer constant lower than the chain transfer constant of the monomer. If the polymer molecular weight is higher than desired, chain transfer agents may be added as needed to control molecular weight. Preferred chain transfer agents include triethylamine, di-n-butyl sulfide, and di-n-butyl disulfide.

Cationic polymerization may be conducted in various solvents and is preferably performed by intermixing an acid with the monomers. The amount of acid is preferably in the range of about 0.001% to about 1%, by weight based on monomer weight, depending on the molecular weight desired for the resulting polymer. Suitable acids include protonic acids and Lewis acids. Protonic acids preferably comprise an anion that is not highly nucleophilic, to reduce termination of the growing polymer chain by combination. Preferred protonic acids include perchloric, sulfuric, phosphoric, fluoro- and chlorosulfonic, methanesulfonic and trifluoromethanesulfonic. Lewis acids are preferred for obtaining high molecular weight polymers. Preferred Lewis acids include metal halides (e.g., AlCl₃, BF₃, SnCl₄, SbCl₅, ZnCl₂, TiCl₄, and PCl₅), organometallic derivatives (e.g., RAlCl₂, R₂AlCl, R₃Al, where R is C₁-C₅ alkyl), and oxyhalides (POCl₃, CrO₂Cl, SOCl₂, and VOCl₃). Polymerization using Lewis acids is preferably conducted in a polar aprotic solvent such as tetrahydrofuran that contains a small amount of a proton donor such as water or an alcohol, or more preferably a small amount of a cation donor such as t-butyl chloride.

Polymerization by transition metal catalysis is preferably conducted by intermixing the monomers with a transition metal catalyst. The amount of transition metal catalyst is preferably in the range of about 0.001% to about 1%, by weight based on monomer weight. Preferred transition metal catalysts comprise a Group I-III organometallic compound (or hydride) and a compound of a Group IV-VIII transition metal. Examples of suitable Group I-III organometallic compounds include RₙAlCl₃₋ₙ, R₂Be, R₂Mg, RLi, R₄AlLi, RNa, R₂Cd, R₃Ga and phenylmagnesium bromide, where n is 1, 2 or 3 and R is C₁-C₅ alkyl. Examples of Group IV-VIII transition metal compounds include TiCl₄, TiCl₃, TiBr₃, VCl₄, VCl₃, R₂TiCl₂, Ti(OR)₄, Ti(OH)₄, MoCl₅, NiO, CrCl₃, ZrCl₄, WCl₆, and MnCl₂, where R is C₁-C₅ alkyl. Since many of these compounds are water sensitive, polymerizations are preferably conducted in dry aprotic solvents such as alkanes, tetrahydrofuran, dioxane, etc.

Copolymerizations can be conducted using chain polymerization techniques and various mixtures of monomers. Preferably, a tertiary aryl amine monomer is intermixed with a comonomer and polymerized as described above to form a copolymer. The comonomers can be intermixed prior to polymerization, or added over the course of the polymerization, individually or in combination. Suitable comonomers include the tertiary aryl amine monomers described herein, as well as other monomers. Preferably, copolymerizations are conducted using comonomers having mutually compatible polymerizable groups, so that a desirable distribution of comonomer recurring units in the resulting copolymer is obtained. Copolymerizable monomers include C₁-C₁₈ alkyl acrylates, C₁-C₁₈ alkyl methacrylates, C₂-C₆ hydroxyalkyl acrylates, C₂-C₆ hydroxyalkyl methacrylates, styrene, C₁-C₅ substituted styrenes, acrylamide, C₁-C₄ substituted acrylamides, acetylene, ethylene, vinyl halide, tetrafluoroethylene, vinyl acetate, butadiene, C₁-C₁₈ alkyl-substituted 1-alkenes, C₁-C₁₈ alkoxy-substituted 1-alkenes, C₇-C₁₄ cyclic N-phenyliminocarbonate, C₁-C₁₀ cyclic acid anhydride, C₁-C₁₀ sultam, C₁-C₁₀ lactam, C₁-C₁₀ lactone, and C₁-C₁₀ cyclic ether (e.g., epoxy).

Amounts of comonomers used are preferably in the range of nil to about 99.9%, more preferably about 0.01% to about 25%, by weight based on total weight of monomers, to produce copolymers having the corresponding levels of recurring units. More preferably, the comonomer content (if any) is adjusted to control the properties of the resulting polymer, e.g., to adjust solubility, glass transition temperature (Tg), melting point, and/or photorefractive properties. Preferably, the polymer has a Tg of about 100° C. or below, more preferably about 20° C. or below. Preferred glass transitions temperatures are preferably achieved by copolymerization with amounts of alkyl acrylates or alkyl methacrylates of the formula CH₂═CR₀—COOR (wherein R₀ represents a hydrogen atom or methyl group, and R represents a C₂-C₁₄ alkyl group) that are effective to produce a polymer having the desired Tg. Highly preferred comonomers for this purpose include butyl (meth)acrylate, ethyl (meth)acrylate, propyl acrylate, 2-ethylhexyl (meth)acrylate and hexyl (meth)acrylate. Excessive amounts of comonomer, however, tend to adversely affect the photorefractive properties of the polymer.

The weight average molecular weights of the polymer are preferably about 1,000 or greater, more preferably in the range of about 3,000 to about 500,000, most preferably in the range of about 5,000 to about 100,000. Molecular weights are preferably measured by high pressure size exclusion chromatography, using polystyrene standards.

Photorefractive polymers are preferably intermixed or copolymerized with various additives such as sensitizers, charge transport compounds, and/or chromophores to improve the performance of the device into which the polymer is incorporated. In this context, a “sensitizer” is a compound (or mixture of compounds) that increases the polymer's sensitivity to electromagnetic irradiation, and a “chromophore” is a molecule (or mixture of molecules) that can selectively absorb certain wavelengths of electromagnetic radiation. Preferred sensitizers include C₆₀ (fullerene) and 2,4,7-trinitro-9-fluorenone (TNF). Preferred chromophores include the compounds represented by the following structures, in which each R individually represents C₁-C₁₀ alkyl:

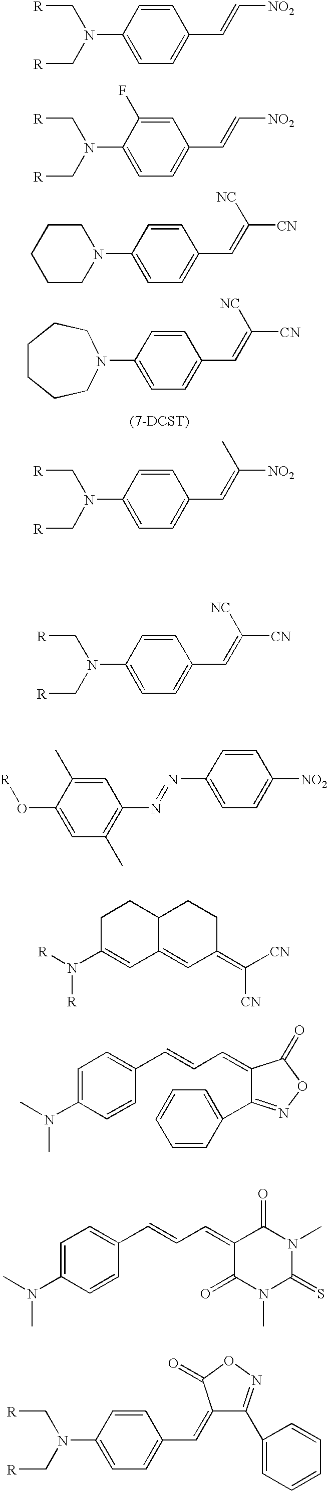

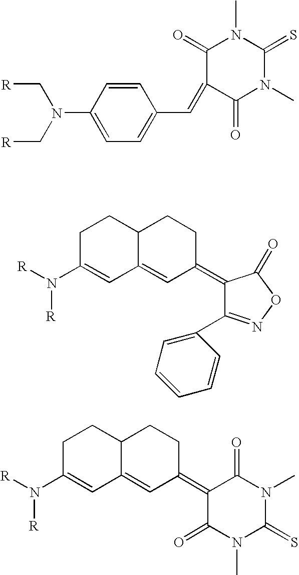

Sensitizers and/or chromophores can be physically intermixed with the polymer. See, e.g., U.S. Pat. No. 5,064,264, which is hereby incorporated by reference. Preferably, the sensitizer and/or chromophore is incorporated into the polymer structure itself by, e.g., copolymerization of the tertiary aryl amine with a comonomer that comprises the sensitizer and/or chromophore. Preferably, the polymer comprises one or more pendant chromophoric groups having a structure selected from the following group:

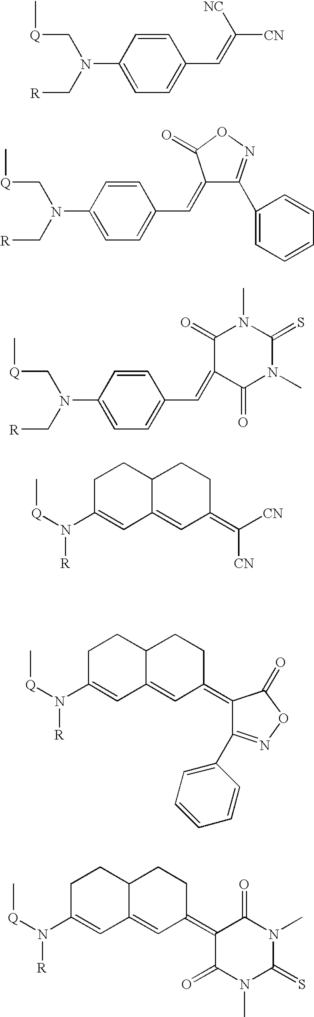

In this context, Q is a linking atom through which the chromophoric group is attached to the rest of the polymer. Preferably, Q represents an alkylene group with or without a hetero atom such as oxygen or sulfur. More preferably, Q represents an alkylene group represented by (CH₂)ₚ, where p is in the range of about 2 to about 6, and R is preferably C₁-C₁₀ alkyl, more preferably C₁-C₃ alkyl.

There are no restrictions as to the amount (if any) of additive, e.g., sensitizers, charge transport compounds, and/or chromophores, intermixed with the tertiary aryl amine polymer (and/or incorporated by copolymerization). Preferably, the amount of sensitizer is about 5% or less, more preferably about 3% or less, by weight based on the amount of tertiary aryl amine polymer. Preferably, the weight ratio of charge transport compound to tertiary aryl amine polymer is in the range of about 1:4 to about 4:1, more preferably in the range of about 1:2 to about 2:1. Preferably, the weight ratio of chromophore to tertiary aryl amine polymer is in the range of about 1:4 to about 4:1, more preferably in the range of about 1:2 to about 2:1.

Image correction devices comprising the polymers described herein preferably display improved performance. In this context, those skilled in the art will understand that reference hereinbelow to “polymers” includes the various tertiary aryl amine polymers discussed above (including copolymers), as well as mixtures of these polymers with the various additives discussed above. In addition, it will be understood by those skilled in the art that the various preferred embodiments of image correction devices described below are merely illustrative, and do not limit the scope of the invention.

Preferred photonics devices employ a photorefractive polymer in which the refractive index is altered by irradiation and/or application of an electric field. By irradiating a photorefractive polymer with a laser, its refractive index can be altered. Once the laser irradiation stops, the refractive index can be returned to the original index. These properties can be employed in various kinds of photonics devices. In preferred embodiments, two laser beams interfere with one another to create a diffraction pattern within a photorefractive polymer. The diffraction pattern can be permanent or temporary, and can be used for various purposes, such as to store information encoded by one of the laser beams, or to alter the properties of light passing through the photorefractive polymer. In some embodiments, the diffraction pattern within the photorefractive polymer is modified by applying an electric field.

Preferred photorefractive effects are obtained in photorefractive polymers that combine good charge generation, good charge transport, or photoconductivity, and good electro-optical activity. Highly preferred photorefractive compositions have the following capabilities: (1) ability to generate a photo-electron (photo-sensitizer part), (2) charge transportability (to carry the generated hole effectively), and (3) nonlinear optical ability to give electro-optical effects (Pockels effect).

### EXAMPLES

### Production Example 1

(a) Monomers Containing Charge Transport Groups

(i) TPD Acrylate Monomer:

TPD acrylate type charge transport monomers (N-[(meth)acroyloxypropylphenyl]-N,N′,N′-triphenyl-(1,1′-biphenyl)-4,4′-diamine) (TPD acrylate) was purchased from Fuji Chemical, Japan:
The TPD acrylate type monomer had the structure:

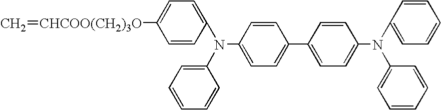

TPD acrylate monomer was prepared by the following procedure.

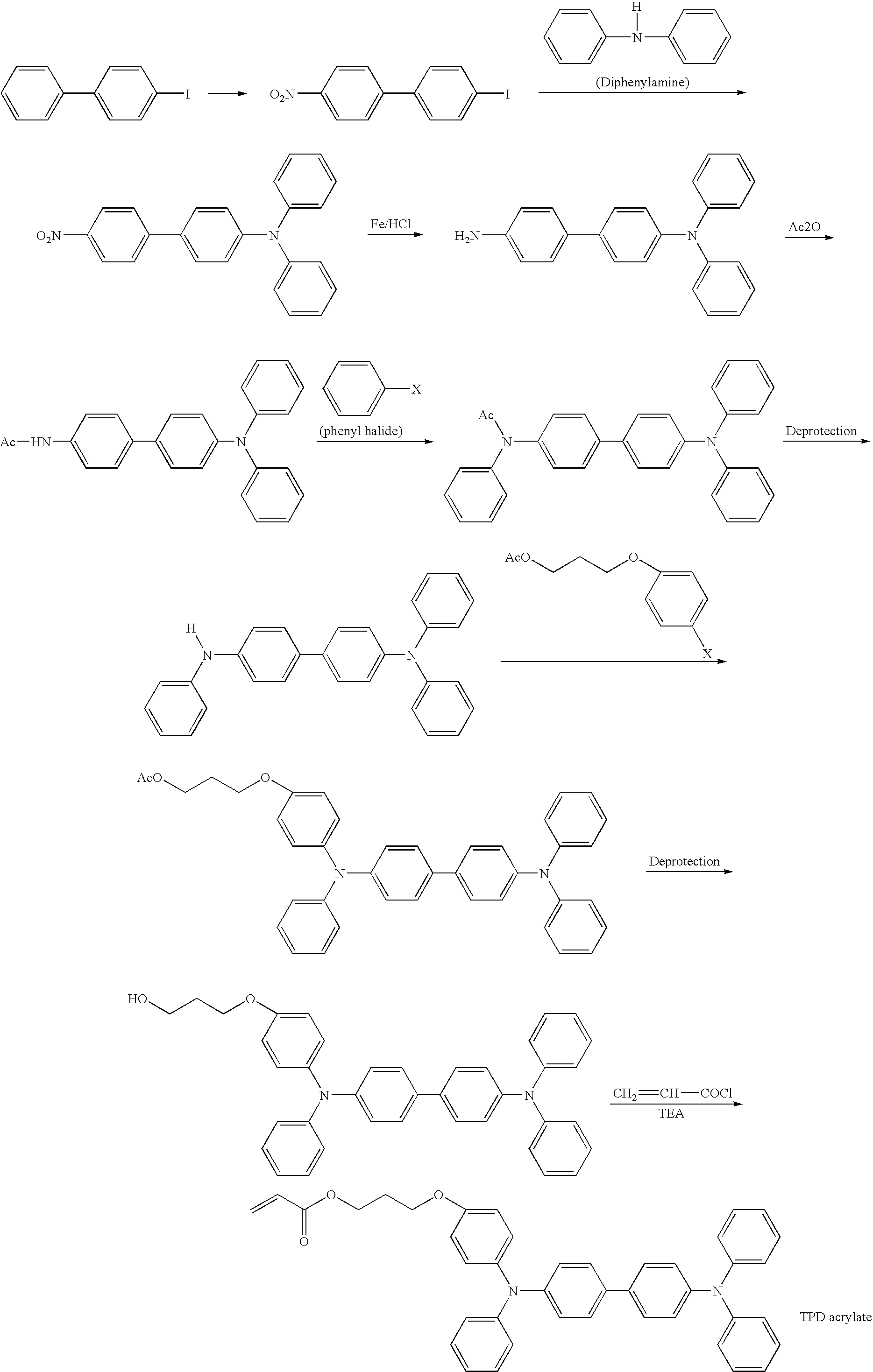

In the above procedure, usage of 3-methyl diphenylamine instead of diphenylamine and 3-methylphenyl halide instead of phenyl halide can result in the formation of N(acroyloxypropylphenyl)-N′-phenyl-N,N′-di(3-methylphenyl)-(1,1′-biphenyl)-4,4′-diamine.

c) Synthesis of Non-Linear-Optical Chromophore

i) 7-FDCST

The non-linear-optical precursor 7-FDCST (7 member ring dicyanostyrene, 4-homopiperidino-2-fluorobenzylidene malononitrile) was synthesized according to the following two-step synthesis scheme:

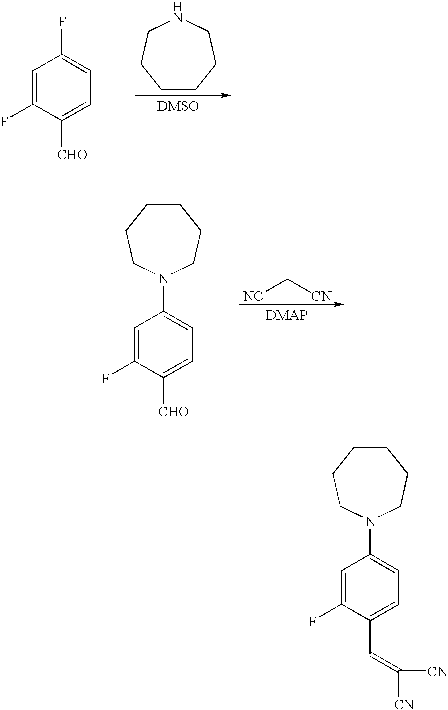

A mixture of 2,4-difluorobenzaldehyde (25 g, 176 mmol), homopiperidine (17.4 g, 176 mmol), lithium carbonate (65 g, 880 mmol), and DMSO (625 mL) was stirred at 50° C. for 16 hr. Water (50 mL) was added to the reaction mixture. The products were extracted with ether (100 mL). After removal of ether, the crude products were purified by silica gel column chromatography using hexanes-ethyl acetate (9:1) as eluent and crude intermediate was obtained (22.6 g,). 4-(Dimethylamino)pyridine (230 mg) was added to a solution of the 4-homopiperidino-2-fluorobenzaldehyde (22.6 g, 102 mmol) and malononitrile (10.1 g, 153 mmol) in methanol (323 mL). The reaction mixture was kept at room temperature and the product was collected by filtration and purified by recrystallization from ethanol.

Yield (18.1 g, 38%)
ii) Synthesis of Fused Ring Chromophore RLC (3a) and APDC (3b) 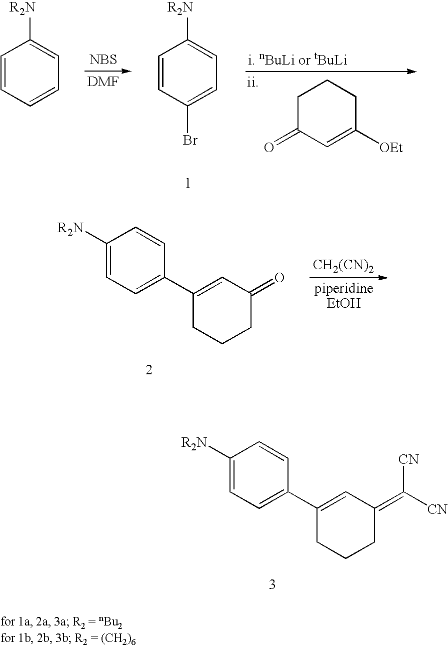
ii-a) RLC (3a)

4-Bromo-N,N-di-n-butylaniline (1a). A solution of N-bromosuccinimide (9.61 g, 0.054 mol) in 25 mL DMF (25 mL) was added to a stirred solution of N,N-di-n-butylaniline (11.0 g, 0.054 mol) in 25 mL N,N-dimethylformamide at 0° C. The resulting green solution was stirred for 12 h at ambient temperature and then poured into 1 L water. The mixture was extracted three times with dichloromethane. The combined organic layers were washed subsequently with water and 200 mL of saturated sodium thiosulfate solution, dried over sodium sulfate, filtered and evaporated to yield 1a as a yellowish oil (14.2 g, 0.050 mol, 93%). ¹H NMR (300 MHz, CDCl₃) 7.23 (d, J=9.1 Hz, 2H, CH); 6.48 (d, J=9.0 Hz, 2H, CH); 3.21 (t, J=8.5 Hz, 4H, CH₂N); 1.52 (q, J=7.6 Hz, 4H, CH₂); 1.34 (q, J=7.3 Hz, 4H, CH₂); 0.93 (t, J=7.3 Hz, 6H, CH3).

2a. n-Butyllithium (18.9 mL of a 2.5 M solution in hexanes, 0.047 mol) were added to a solution of 1a (12.3 g, 0.043 mol) in dry diethyl ether at −10° C. After stirring for 2 h at −10° C., the reaction mixture was allowed to warm up to 0° C. A solution of 1-ethoxy-2-cyclohexen-3-one (6.02 g, 0.043 mol) in diethyl ether was added. The reaction mixture was warmed to ambient temperature and stirred for 2.5 h. After addition of a saturated aqueous solution of sodium chloride, the organic layer was separated. The aqueous layer was extracted with two portions of diethyl ether. The combined organic layers were dried over sodium sulfate, filtered and evaporated to give a residue, which was purified by column chromatography on silica gel with a mixture of hexanes and ethyl acetate as eluent to give 2a as a yellow solid (10.2 g, 0.034 mol, 79%). ¹H NMR (300 MHz, CDCl₃) 7.46 (d, J=9.0 Hz, 2H, CH); 6.60 (d, J=8.9 Hz, 2H, CH); 6.38 (s, 1H, CH); 3.29 (t, J=7.6 Hz, 4H, CH₂N); 2.72 (t, J=6.0 Hz, 2H, CH₂); 2.42 (t, J=6.6 Hz, 2H, CH₂); 2.08 (q, J=6.3 Hz, 2H, CH₂); 1.56 (q, J=7.5 Hz, 4H, CH₂); 1.34 (sext, J=7.4 Hz, 4H, CH₂); 0.94 (t, J=7.3 Hz, 6H, CH₃).

3a (RLC). The ketone 2a (2.60 g, 8.7 mmol) was dissolved in the minimum amount of refluxing ethanol and malonodinitrile (3.44 g, 52 mmol) were added, along with a catalytic amount of piperidine. The reaction mixture was stirred at 70° C. for 2 h. The conversion of the starting material was monitored by TLC. The reaction was stopped when a side product was observed. The solvent was evaporated and the dark residue was purified by column chromatography on silica gel with a mixture of hexane and ethyl acetate as eluent, followed by recrystallization from ethanol to yield 3a red needles (1.66 g, 4.8 mmol, 55%) with mp. 101-102° C. ¹H NMR (300 MHz, CDCl₃) 7.56 (d, J=9.1 Hz, 2H, CH): 7.12 (s, 1H, CH); 6.61 (d, J=9.1 Hz, 2H, CH); 3.32 (t, J=7.6 Hz, 4H, NCH₂); 2.75 (t, J=6.4 Hz, 4H, CH₂); 1.95 (quint., J=6.3 Hz, 2H, CH₂); 1.52-1.63 (m, 4H, CH₂); 1.29-1.41 (td, J_{d}=Jₜ=7.5 Hz, 4H, CH₂); 0.95 (t, J=7.3 Hz, 6H, CH₃).

ii-b) APDC (3b)

1-Phenyl-azepane was synthesized from the reaction of azepane (also known as hexamethyleneimine and hexahydroazepine), sodium amide, and bromobenzene according to a literature procedure (R. E. Walkup and S. Searles, Tetrahedron, 1985, 41, 101-106). Other starting materials were obtained commercially.

1-(4-Bromophenyl)azepane (1b). A solution of N-bromosuccinimide (1.789 g, 10.1 mmol) in DMF (15 mL) was added dropwise to a solution of 1-phenyl-azepane (1.768 g, 10.1 mmol) in DMF (25 mL) at 0° C. The mixture was allowed to stir and was quenched with 40 mL water after 48 hours. The product was extracted with three 40 mL portions of diethyl ether. The diethyl ether layer was washed with three 40 mL portions of water, then with two 40 mL portions of aqueous 0.01 M sodium thiosulfate, and dried on magnesium sulfate. The diethyl ether was evaporated to afford 1b as a yellowish oil. (1.9721 g, 77.25 mmol, 77% yield). ¹H NMR (CDCl₃, 250 MHz) 7.23 (d, 2H, J=9.2 Hz), 6.53 (d, 2H, J=9.2 Hz), 3.40 (t, 4H, J=5.9 Hz), 1.74 (m, 4H), 1.51 (m, 4H).

2b. 1-(4-Bromophenyl)-azepane (20 g, 78.7 mmol) was dissolved in dry THF (400 mL) under nitrogen gas and cooled to −78° C. tert-Butyl Lithium (92.6 mL of a 1.7 M solution in pentane, 1.45 mol) was added dropwise to the mixture. A solution of 1-ethoxy-2-cyclohexen-3-one (11.45 mL, 78.7 mmol) in dry THF (80 mL) was added dropwise to the mixture. After 36 hours, the reaction was quenched with water (˜250 mL). Reaction was separated with diethyl ether, washed with a saturated sodium chloride solution and dried on magnesium sulfate. The diethyl ether was evaporated and chromatographed on an 8 cm diameter column eluting with 1:1 hexanes/ethyl acetate solution (yellow solid, 16.13 g, 59.8 mmol, 76%). ¹H NMR (CDCl₃, 250 MHz) 7.46 (d, 2H, J=9.0 Hz), 6.66 (d, 2H, J=9.0 Hz), 6.38 (s, 1H, J=2.035 Hz), 3.48 (t, 4H, J=5.88 Hz), 2.72 (t, 2H, J=5.98 Hz), 2.42 (t, 2H, J=6.23 Hz), 2.08 (m, 2H), 1.77 (m, 5H), 1.53 (m, 4H).

3b (APDC). The ketone 2b (7.50 g, 27.8 mmol) and malononitrile (9.5 g, 143.8 mmol) were dissolved in ethanol (300 mL). Pipiridine (˜5 mL) was added to the reaction mixture. Type 4A molecular sieves were added. The reaction mixture turned dark red after a couple of minutes. The reaction was stopped afer 4.5 hours. The ethanol was evaporated under reduced pressure. The residue was extracted into ethyl actetate, filtered, and recrystallized to yield a red solid. (7.11 g, 22.4 mmol, 80%). ¹H NMR (CDCl₃, 200 MHz) 7.55 (d, 2H, J=8.94 Hz), 7.11 (s, 1H), 6.67 (d, 2H, J=9.1 Hz), 3.51 (t, 4H, J=5.86 Hz), 2.73 (m, 4H), 1.87 (m, 6H), 1.53 (m, 4H).

d) Synthesis of Plasticizer

The plascticizer TPA-Ac was synthesized according to the following synthesis scheme:

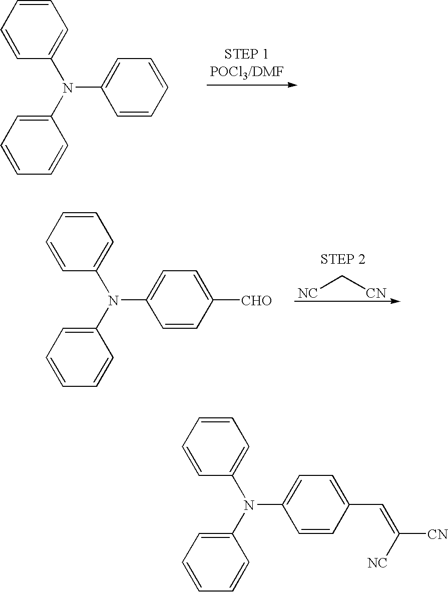

Step 1:

To a cooled solution of DMF anhydride (17 mL) at 0° C. under Argon atomosphere, phosphorousoxychloride anhydride dropwisely (10 mL, 107.3 mmol) was added. After addition completion combined with triphenylamine (30 g, 122.3 mmol) and DMF anhydride (75 mL). Solution was heated to 80° C. overnight. Extracted the reaction mixture with water (500 mL) and CH₂Cl₂ (500 mL). The CH₂Cl₂ layer was rotary-evaporated and purified by column chromatography (7 CH₂Cl₂: 3 hexane). Yield was about 21.9 g (66%)

Step 2:

Triphenylamine aldehyde (1.41 g, 5.16 mmol) and malonodinitrile (450 mg, 6.82 mmol) were dissolved in dry chloroform (20 mL). Then, as a catalysis, dimethylaminopyridine (40 mg) was added into this solution. The reaction mixture turned dark red after a couple of minutes. The reaction was stopped after 18 hours at 40° C. The mixture was evaporated under reduced pressure and chromatographed with 3:2 hexanes/ethyl acetate eluting solution. The product was obtained as red crystals after recrystallization from ethanol. (840 mg, 51% yield).

(e) Other Materials

Besides the above monomers and initiator, other chemicals, such as copper bromide, bipyridine and ethyl 2-bromo-2-methylpropionate, were purchased from Aldrich Chemicals, Milwaukee, Wis.

### Production Example 2

Preparation of homo-polymer by Azo Initiator Polymerization of Charge Transport Homopolymer (TPD Acrylate Type)

The charge transport monomer N-[(meth)acroyloxypropylphenyl]-N,N′, N′-triphenyl-(1,1′-biphenyl)-4,4′-diamine (TPD acrylate, prepared in Production Example 1-(i)) (2.5 g, 4.1 mmol,) was put into a three-necked flask. After toluene (9.8 g) was added and purged by argon gas for 1 hour, azoisobutylnitrile (9.4 mg) was added into this solution. Then, the solution was heated to 65° C., while continuing to purge with argon gas.

After 18 hrs polymerization, the polymer solution was diluted with toluene. The polymer was precipitated from the solution and added to methanol, then the resulting polymer precipitate was collected and washed in diethyl ether and methanol. The white polymer powder was collected and dried. The yield of polymer was essentially 100%.

As before, the weight average and number average molecular weights were measured by gel permeation chromatography, using a polystyrene standard. The results were Mn=8,344, Mw=12,600, giving a polydispersity of 1.51.

### Example

Preparation of Photorefractive Composition

A photorefractive composition testing sample was prepared. The components of the composition were as follows:

| | | |
|---|---|---|
| (i) | TPD charge transport (described in | 60 wt % |
| | Production Example 2): | |
| (ii) | Prepared chromophore of RLC | 14.3 wt % |
| (iii) | Prepared chromophore of APDC | 14.3 wt % |
| (iv) | Prepared TPA Acetate plasticizer | 10.9 wt % |
| (v) | Purchased C60 sensitizer (MER, Tucson, AZ) | 0.5 wt % |

To prepare the composition, the components listed above were dissolved with toluene and stirred overnight at room temperature. After removing the solvent by rotary evaporator and vacuum pump, the residue was scratched and gathered.

To make testing samples, this powdery residue mixture was put on a slide glass and melted at 125° C. to make a 200-300 μm thickness film, or pre-cake. Small portions of this pre-cake were taken off and sandwiched between indium tin oxide (ITO) coated glass plates separated by a 105 μm spacer to form the individual samples.

Measurement

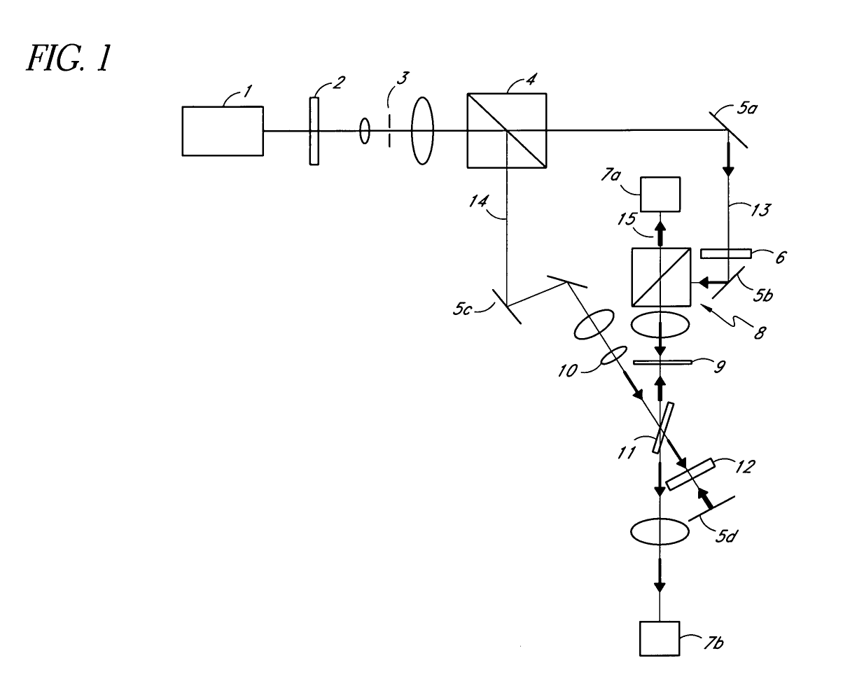

FIG. 1 is a schematic illustration of typical optical setup for image correction device system. The image correction device system comprises a He-Ne Laser 1, Polarizer 2, Beam Expander 3, NP Beam Splitter 4, Mirrors 5a-5d, Object 6, CCD 7a, CCD 7b, Polarizing Beam Splitter 8, Aberrator 9, Telescope 10, PR Polymer 11, and Quarter-wave Plate 12. In experiments, as shown in FIG. 1, a beam from a He-Ne laser 1 at 633 nm was spatially filtered, collimated, and split into an object beam 13 and a reference beam 14, both s-polarized. The object beam 13 transmitted through a resolution target (object 6) and a phase aberrator 9 and was Fourier transformed to the testing sample. In order to record both lower- and higher-order diffracted information, the sample was slightly defocused. The angle between the two writing beams was 22° and the normal to the sample and the bisector of the two writing beams formed an angle of 55°. A p-polarized beam 15 from the same laser counter-propagating to the reference beam was used to read a PR hologram, generating a phase conjugated object beam. When the phase-conjugated object beam passed through the aberrator again, a corrected image was obtained.

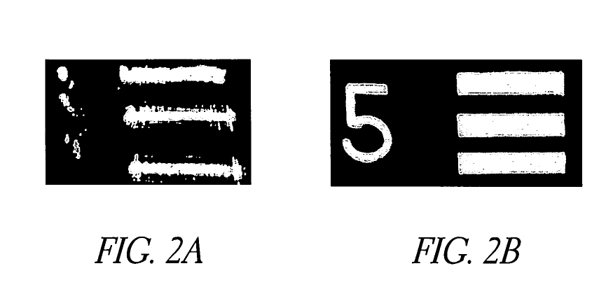

FIGS. 2(A) and 2(B) are typical image results before and after image correction, respectively. FIG. 2(A) shows a transmitted image received by CCD 7b which is a distorted image. FIG. 2(B) shows a restored image received by CCD 7a which is a corrected image. Further, in order to demonstrate the functionality of the system, the distorted image and the restored image were compared without the aberrator and with aberrators of different distortions (data not shown). The transmitted image received by CCD 7b through the aberrator 9 was degraded. Especially when the distortion of the aberrator 9 was significant, the transmitted image could be recognized. In contrast, the restored image received by CCD 7a through the aberrator 9 and the PR polymer 11 again was always corrected. In addition, the restored image had as high a contrast as the transmitted image. Initial spatial resolution of 30 μm was obtained. In the above, the image quality can be improved by using a larger-area PR sample. Furthermore, edge detection can also be performed with the same setup by adjusting the sample position and intensity ratio of the two writing beams.

In the present invention, photorefractive (PR) polymers can have any suitable configurations and can be adapted to any suitable image correction devices. Image correction devices can be image devices equipped with image correction systems using PR polymers or image restoring devices using PR polymers. The image correction system of the present invention can be in any form, including a combination of a PR polymer plate or lens and an aberrator, a combination of a PR polymer plate or lens, an aberrator, and a polarization system, and a combination of a PR polymer plate or lens, an aberrator, a polarization system, and a beam splitting and combining system. Further, the system can include an image receiving device such as a CCD camera. Furthermore, the present invention includes a PR polymer itself for image correction.

It will be understood by those of skill in the art that numerous and various modifications can be made without departing from the spirit of the present invention. Therefore, it should be clearly understood that the forms of the present invention are illustrative only and are not intended to limit the scope of the present invention.

1. An image correction device comprising a photorefractive polymer, wherein the photorefractive polymer comprises a tertiary aryl amine selected from the group consisting of: 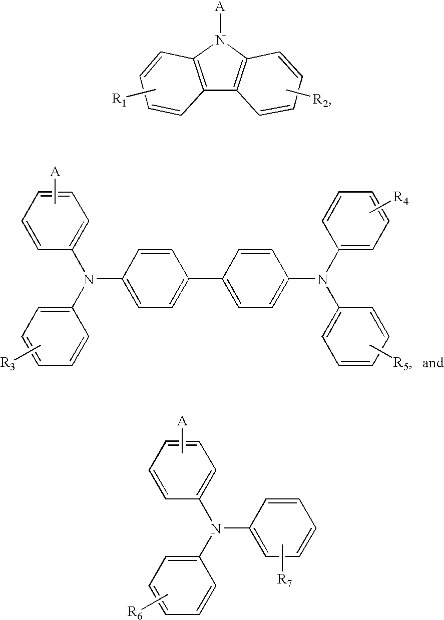
wherein A is a linking atom, and
wherein R₁, R₂, R₃, R₄, R₅, R₆, and R₇ are each independently selected from the group consisting of hydrogen, C₁-C₁₀ alkyl, C₁-C₁₀ alkoxy, and C₆-C₁₀ aryl.

2. The image correction device according to claim 1, wherein the photorefractive polymer comprises a structure obtained by polymerizing monomers each containing the tertiary aryl amine and a polymerizable group coupled therewith via the linking atom.

3. The image correction device according to claim 1, wherein the photorefractive polymer comprises the tertiary aryl amine as a side chain.

4. The image correction device according to claim 1, wherein the photorefractive polymer is provided in form of a film on a glass or lens, through which a restored image is obtained.

5. A method for correcting wavefront distortion of an image of a target, comprising passing through the photorefractive polymer set forth in claim 1 a light beam transmitted through the target.
